(19) United States
(12) Patent Application Publication
(10) Pub. No.: US 2019/0127633 A1
(43) Pub. Date: May 2, 2019

(54) MECHANOLUMINESCENCE MATERIALS AND METHOD FOR MANUFACTURING SAID MATERIALS

(71) Applicants: UNIVERSITÉ D'ANGERS, Angers (FR); CENTRE NATIONAL DE LA RECHERCHE SCIENTIFIQUE, Paris (FR); CONSIGLIO NAZIONALE DELLE RICERCHE (CNR), Rome (IT)

(72) Inventors: Oksana TOMA, Angers (FR); Nicolas MERCIER, Angers Cedex (FR); Chiara BOTTA, Milan (IT)

(21) Appl. No.: 16/077,593

(22) PCT Filed: Feb. 10, 2017
(86) PCT No.: PCT/FR2017/050305

§ 371 Date: Dec. 31, 2018

(30) Foreign Application Priority Data
Feb. 11, 2016 (FR) 1600232

(51) Int. Cl. C09K 11/06

(52) U.S. Cl. CPC C09K 11/06; C09K 2211/18; C09K 2211/1029

(57) ABSTRACT

Some embodiments are directed to a mechanoluminescence material including a first compound and a second compound, each of which contains a bi-pyridine or pyridine that includes an N-oxide group bound to an ns² metal cation from the p block. The second compound of the material is obtained by grinding a compound that is identical to the first one.

### CROSS REFERENCE TO RELATED APPLICATIONS

This application is a national phase filing under 35 C.F.R. § 371 of and claims priority to PCT Patent Application No. PCT/FR2017/050305, filed on Feb. 10, 2017, which claims the priority benefit under 35 U.S.C. § 119 of French Patent Application No. 1600232, filed on Feb. 11, 2016, the contents of each of which are hereby incorporated in their entireties by reference.

### BACKGROUND

The presently disclosed subject matter relates to the field of luminescent materials, and more particularly, to mechanoluminescence materials.

Multiple applications exist and which use the luminescence properties of materials. Applications are widely known to the general public in the fields of lighting and display, for example. Other applications are more specific and aim, still by way of example, to allow for a visual marking. This type of marking can be applied to medical use, with in particular the capacity to carry out and implement luminescence markers in order to follow a cell development in vitro. Such luminescence materials are most often obtained by chemical synthesis operations.

The scientific publication “Aggregation induced phosphorescent N-oxide-2,2′-bipyridine bismuth complexes and polymorphism-dependent emission” (Nicolas Mercier, . . . ; Dalton Transactions 2015) describes luminescence properties of a bipyridine N-oxide bismuth complex.

Materials exist furthermore and make it possible to modulate the luminescence that is proper to them by application of a mechanical stress (pressure, friction, for example). These materials are said to be mechcanoluminescent. They are in particular used in applications for authenticating documents, in particular fiduciary documents. International patent application WO2014/090839 A1 (Method for checking the authenticity of a security document”, OBERTHUR FIDUCIAIRE, 11 Dec. 2013) describes a method of verification that uses a reversible mechanoluminescence compound.

However such materials are generally organic compounds derived from pyrene or anthracene obtained via relatively complex synthesis operations or coordination complexes with a base of extended ligands, produced by a synthesis in several steps and of metals such as gold, platinum or iridium, for example. These metals are particularly expensive, consequently the manufacturing of the compounds described is also expensive.

The existing solutions have disadvantages.

### SUMMARY

The presently disclosed subject matter makes it possible to improve the state of the art by proposing a material including a first compound and a second compound. These first and second compounds include a bi-pyridine or pyridine group itself including an N-oxide group. The N-oxide group is bound to a metal cation of the type ns² type of the p group. According to the presently disclosed subject matter, the second compound is obtained from a compound identical to the first compound, via a grinding operation. As such, the first ground compound constitutes the second compound.

According to an embodiment, the material further includes a third compound obtained from the second compound subjected to a predetermined rise in temperature.

According to an alternative, the third compound of the material is obtained from the second compound subjected to steam.

According to another alternative, the third compound is obtained from the second compound subjected to the vapour of an organic solvent or directly to the organic solvent, of the acetonitrile or acetone type.

Some embodiments also relate to a method of manufacturing a material including a first compound and a second compound, with the first and second compounds each including a bi-pyridine or pyridine group itself including an N-oxide group, the N-oxide group being bound to a metal cation of the ns² type of the p group, and the method of manufacturing being characterised in that it includes:
a synthesis for the purpose of obtaining the first compound, and,
a grinding operation of a portion of the first compound obtained for the purpose of obtaining the second compound via partial or total amorphisation.

Advantageously, the two compounds obtained as such then have different photoluminescent characteristics, in particular when they are subjected to ultra-violet radiation.

### BRIEF DESCRIPTION OF THE FIGURES

Some embodiments shall be better understood, and other particularities and advantages shall appear when reading the following description, with the description making reference to the accompanying drawings among which:

FIG. 1 shows the basic structure of a material including a bi-pyridine or pyridine group, itself including an N-oxide group, the N-oxide group being bound to a metal cation of the ns² type of the p group.

FIG. 2 shows the formula of a N-oxide-4,4′-bipyridine ligand, here the N,N′-dioxide-4,4′-bipyridine available commercially, and used in order to obtain the structure of the coordination polymer COMP1 shown in FIG. 1.

FIG. 3 is a symbolic representation of a unit of material MAT according to some embodiments.

FIG. 4 symbolises two materials obtained successively by the implementing of a method for obtaining an electroluminescence material MAT according to a first particular and non-limiting embodiment.

FIG. 5 symbolises three materials obtained successively by the implementation of a method for obtaining an electroluminescence material MAT according to a second particular and non-limiting embodiment.

### DETAILED DESCRIPTION OF EXEMPLARY EMBODIMENTS

In FIGS. 1 to 5, the modules shows are functional units, which correspond or not to units that can be physically distinguished. For example, these modules or some of them are grouped together into a single component, or include functionalities of the same software. A contrario, according to other embodiments, certain modules include physically separated entities.

FIG. 1 shows a base structure C1STRUCT (framed by a rectangle) of a material including a bi-pyridine or pyridine group, itself including an N-oxide group, the N-oxide group being bound to a metal cation of the ns² type of the p group. This structure C1STRUCT corresponds to that of the first compound COMP1 of the material MAT according to a particular and non-limiting embodiment.

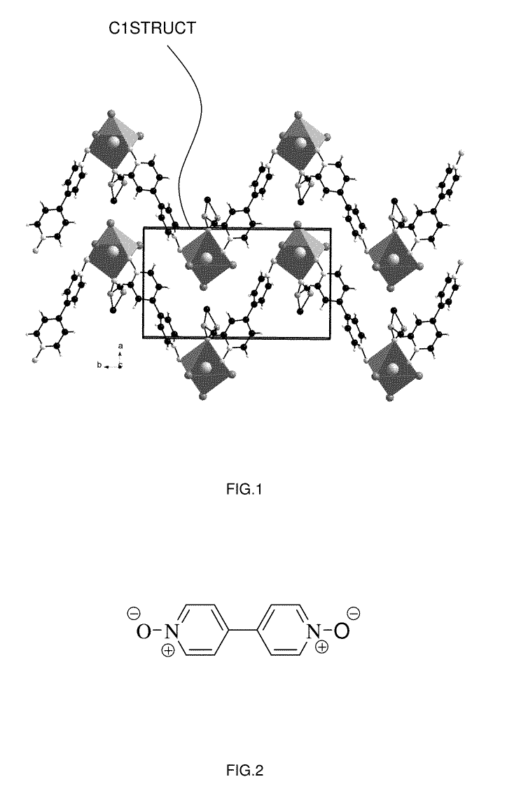

According to a particular and non-limiting embodiment, the coordination polymer shown in FIG. 1, with a N,N′-dioxide-4,4′-bipyridine bismuth base, is obtained by dissolving an equivalent of the N,N′-dioxide-4,4′-bipyridine ligand (shown in FIG. 2) in 10 ml of dimethyl sulfoxide, in the presence of an equivalent of the bismuth salt BiBr₃.

FIG. 2 shows the formula of a N-oxide-4,4′-bipyridine ligand, the N,N′-dioxide-4,4′-bipyridine available commercially, and used for obtaining the structure of the coordination polymer COMP1 shown in FIG. 1. Of course this ligand is not the only one able to be used for the purpose of preparing the compound COMP1 and equivalents can also be used for the purpose of obtaining the compound COMP1.

Advantageously, the dissolution of the ligand mentioned, available commercially, in dimethyl sulfoxide and in the presence of bismuth salt, makes it possible to obtain a reaction medium that is suitable for the manufacture of the compound COMP1 having the crystalline structure shown in FIG. 1. The preparation of the compound COMP1 can be carried out, for example, by first placing the reaction medium obtained in a container, such as, by way of example, a pill organiser. The polymer COMP1 can then be obtained, after a few days, in the form of crystals, by then placing the container in a container of a larger size, containing ethyl acetate, with the whole being sealed.

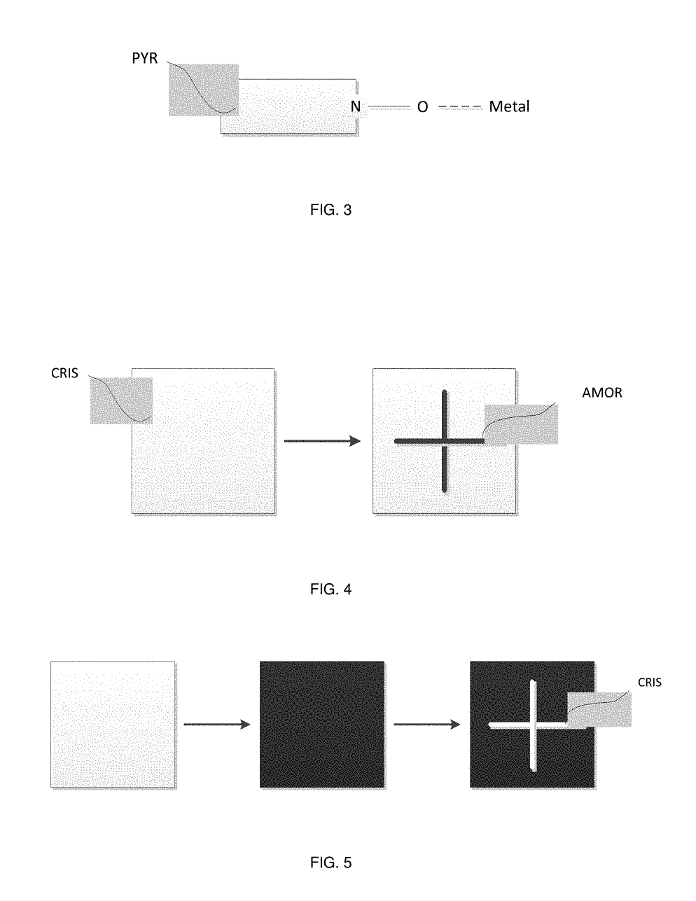

FIG. 3 is a symbolic representation of a unit of the compound material COMP1 according to an embodiment. The unit (the elementary structure) shown includes a bi-pyridine or pyridine group PYR itself including an N-oxide group N—O. The N-oxide group is bound to a metal cation of the ns² type of the p group.

FIG. 4 symbolises two materials obtained successively by the implementation of a method for obtaining a photoluminescence material MAT according to a first particular and non-limiting embodiment. The material shown on the left in FIG. 4 is the compound COMP1, characterised by its crystalline structure CRIS, obtained by the steps of the method, such as described hereinabove. The material MAT, shown on the right in FIG. 4 is obtained from the material COMP1, by partially grinding (in this example) the surface of the material COMP1. The localised grinding operation, according to a unit (or drawing) in the shape of a cross, results in the obtaining of an amorphous structure AMOR over the entire unit carried out as such.

In other terms, the material MAT according to some embodiments, shown on the right in FIG. 4, includes a first compound COMP1, of crystalline structure CRIS and a second compound COMP2, obtained via a localised grinding, forming the compound COMP2 of amorphous structure AMOR according to a unit in the shape of a cross. The compounds COMP1 of structure CRIS and COMP2 of structure AMOR, each include a bi-pyridine or pyridine group PYR itself including an N-oxide group N—O. The N-oxide group N—O is bound to a metal cation of the ns² type of the p group. The difference between the compounds COMP1 and COMP2 then resides, due to the grinding operation carried out, in their respective structures CRIS and AMOR.

Advantageously, the compounds COMP1 and COMP2 consequently have at grinding different photoluminescence characteristics, in particular under ultra-violet radiation, due to their own structures, cleverly creating a contrast when the whole of the element is subjected to a radiation of a predefined type.

FIG. 5 symbolises three materials obtained successively through implementing a method for obtaining a photoluminescence material MAT according to a second particular and non-limiting embodiment. The material shown on the left in FIG. 5 is the compound COMP1, characterised by its crystalline structure CRIS, obtained by the steps of the method, such as described hereinabove. The material MAT, shown in the centre in FIG. 5 is obtained from the material COMP1, by grinding the entire surface of the material COMP1. The total grinding operation of the surface, uniform, results in the obtaining of an amorphous structure AMOR over the entire surface.

The material MAT, shown on the left in FIG. 5 is obtained from the compound COMP1, by grinding all or most of its surface then made from the compound COMP2, then by proceeding with an increase in the temperature, an application of vapour of a solvent or of an organic solvent of the acetonitrile or acetone type, or of steam, according to a unit in the shape of a cross in the example shown in FIG. 5. At the centre, the total grinding operation of the surface of COMP1, uniform, results in the obtaining of a compound COMP2 of amorphous structure AMOR over the entire surface. Then, on the right, the localised increase in temperature or the localised application of a vapour of a solvent or of a solvent according to a predetermined unit (here in the shape of a cross) makes it possible to advantageously generate a contrast by covering a crystalline structure CRIS at the location of the unit, similar to the starting structure (of COMP1). The similar structure found as such constitutes a third compound COMP3.

Advantageously, the compounds COMP1 and COMP2 have, due to the application of a mechanical stress of the type crushing or friction, for example (grinding), disparate luminescent characteristics.

The same applies for the compounds COMP2 and COMP3. As such, the same element can carry one or several inscriptions whatsoever, which can be revealed to the eye under an ultra-violet radiation. These luminescent characteristics allow for applications concerning authentication, tracking, assistance with traceability, fight against counterfeiting.

Advantageously, the application of an ultra-violet radiation on a deformable object makes it possible to view gradients of luminescence that represent the mechanical stresses to which the object was previously subjected. This can be the case, by way of example, for tests and evaluations in the fields of aeronautics (model testing in wind tunnels), automobile, or more widely in resistance of materials. With this in mind, the application of a compound with properties similar to those of the compound COMP1 on the surface of a model subjected to forces (mechanical stresses) results in the creation on the surface of a material MAT according to some embodiments since the forces carry out a surface grinding that transforms, locally according to the amplitude of the forces and according to the topology of the object, the compound COMP1 into compound COMP2. The model then subjected to an ultra-violet radiation is representative of the forces to which it has been subjected, due to the gradients of luminescence created and local reflection disparities. The ultra-violet radiation reveals to the eye a representation of the undergone stresses. Advantageously, it is possible to erase these gradients after study or analysis, by application of an increase in temperature or of a solvent, suitable for the returning to a crystalline structure CRIS of the previously amorphised material according to a structure AMOR. This erasing operation transforms the zones of compound COMP2 into a compound COMP3 close to the original compound COMP1.

The presently disclosed subject matter does not relate to only the embodiment described hereinabove but more largely relates to any material including a first compound and a second compound both including a bi-pyridine or pyridine group, which itself includes an N-oxide group, bound to a metal cation of the ns² type of the p group, and wherein the second compound is obtained from the first compound, coming from a synthesis operation, via a grinding operation (crushing, pressure, friction).

1. A material, comprising:
a first compound; and
a second compound,
wherein the first and second compounds include a bi-pyridine or pyridine group including itself an N-oxide group, the N-oxide group being bound to a metal cation of the ns² type of the P group, and the second compound being obtained from a compound identical to the first compound and is ground.

2. The material according to claim 1, further comprising a third compound obtained from the second compound subjected to a predetermined rise in temperature.

3. The material according to claim 1, further comprising a third compound obtained from the second compound subjected to steam.

4. The material according to claim 1, further comprising a third compound obtained from the second compound subjected to an organic solvent vapour or directly to an organic solvent of the acetonitrile or acetone type.

5. A method for manufacturing a material that includes a first compound and a second compound, the first and second compounds each including a bi-pyridine or pyridine group including itself an N-oxide group, the N-oxide group being bound to a metal cation of the ns² type of the p group, the method comprising:
performing a synthesis in order to obtain the first compound; and,
grinding a portion of the first compound obtained for obtaining the second compound via partial or total amorphisation.
